(19) United States
(12) Patent Application Publication
(10) Pub. No.: US 2020/0034391 A1
(43) Pub. Date: Jan. 30, 2020

(54) TRUSTED DOCUMENT UPDATING METHOD

(71) Applicant: Fujian Foxit Software Development Joint Stock Co., Ltd., Fuzhou, Fujian (CN)

(72) Inventors: Kai Jing, Fuzhou, Fujian (CN); Fangming Liu, Beijing (CN)

(21) Appl. No.: 16/490,432

(22) PCT Filed: Apr. 1, 2017
(86) PCT No.: PCT/CN2017/000272

§ 371 Date: Aug. 30, 2019

(51) Int. Cl. G06F 16/93; G06F 17/22; G06Q 10/10; G06F 16/21; G06F 16/23

(52) U.S. Cl. CPC G06F 16/93; G06F 17/2288; G06F 16/23; G06F 16/219; G06F 17/2247; G06Q 10/10

(57) ABSTRACT

In a trusted document updating method, a globally-unique document identifier and an access address of a corresponding cloud server are set in each managed document. Characteristic data of a version that is not modified and characteristic data of a new version are submitted to a cloud server. Version characteristic update information is recorded. The cloud server and a tree-shaped data structure are accessed. The cloud server removes a leaf node a corresponding author of which is not a neighbor in the tree-shaped data structure. All leaf nodes in a subtree using current document eigenvalue as a root are added into a list of “a latest edition of a current version.” Data of a corresponding version is downloaded from the cloud server according to a version selected by the user.

### TECHNICAL FIELD

The present invention relates to a technical field of a computer application, in particular, to a method for providing a trusted document update.

### BACKGROUND OF THE INVENTION

In a document management system, the storage of the latest version of a document can be thought as a mapping of the document entry to the data of the latest document version.

To update a document to the latest version stored in the document management system, a user needs to obtain the latest version of the corresponding document entry from the server, overwrite the content in the local copy, and then load and process it. To update a document by a friend/neighbor user to the latest modification of the document in the document management system, it is necessary to automatically or manually query each friend/neighbor user, whether it has a document with the same characteristics, and select the version whose modification date is closest to the current version, overwrite the content in the local copy after downloading, then load and process it.

The shortcomings of the solutions by the present art are obvious. Firstly, it is impossible to judge whether the existing document data is already up-to-date, resulting in the necessity of blindly acquiring data from the document management system, which increases the time cost of document processing; secondly, there is no effective means to verify that the neighbor's documents have the same source information, and to verify that the last modification is made on the latest version at the time, which contains the revision data of all previous others; what is more, for the document management system in network environment, such processing can result in a large amount of redundant data transmission, the frequent use of it may even cause local network to paralyze.

### SUMMARY OF THE INVENTION

The present invention provides a method for updating a trusted document to solve the version control problem caused by multiple-editing and -review operations when updating a document subscription in the document management system.

To achieve the above object, the present invention provides a method for providing a trusted document update, comprising following steps:

Setting a globally unique document identifier in each managed document, and setting an access address of a corresponding cloud server in a document;

Transmitting a pre-version version characteristic data that is not modified and a new version characteristic data that is modified to the cloud server each time the document is modified by a modifier, said cloud server records version characteristic update information of the document according to the document identifier of the document and identity information of the modifier, wherein, the version characteristic data information corresponding to each document identifier is stored in a tree data structure; wherein, a subtree represents descendants of a node in the tree data structure; a leaf node is a node without any node below itself and directly connected with itself downward; a root is a node at the top in the tree data structure or in a subtree;

When the document is opened, accessing the cloud server by using the set access address, wherein, said cloud server accesses the tree data structure corresponding to a document identifier of a current document according to the document identifier and characteristic value information of the current document;

Said cloud server removing a leaf node whose author is not a friend/neighbor of a current user in said tree data structure according to friend/neighbor information of the current user;

For the tree data structure after said leaf node is removed, adding all leaf nodes in a subtree into a list of a “latest edition to the current version”, wherein, the characteristic value information of the current document is a root of the subtree;

According to the version in the “latest edition to the current version” list selected by the current user, downloading the corresponding version of the data from said cloud server to overwrite a content in the local copy of the current user, and then loading and processing it.

Further, the method for providing a trusted document update comprises the following steps:

For the tree data structure after said leaf node is removed, adding leaf nodes not in the list of the “latest edition to the current version” into the a list of a “latest edition to other versions of the current document”;

According to a version selected by the current user in the list of the “latest edition to other versions of the current document”, downloading data corresponding to the version from said cloud server so as to overwrite the content in the local copy of the current user, and then loading and processing it.

Further, wherein the document is a paged media electronic document.

Further, wherein said cloud server has pre-uploaded friend/neighbor information of the current user.

The invention uses the version derivation tree under the document entry to manage the document version, and uses the document characteristic data instead of the full document identification version, thus the user needs to transmit less data to see all relevant updated versions information to select from, thereby increasing efficiency; the method ensures that the range of data obtained is from trusted neighbors. Thus this invention ensures the trustworthiness of the update results and the integrity of the information.

### BRIEF DESCRIPTION OF THE DRAWINGS

In order to more clearly illustrate the embodiments of the present invention, or the technical solutions in the prior art, the attached FIGURES used in the embodiments or the description of the prior art will be briefly described below. Obviously, the attached FIGURES in the following description are only some of the embodiments of the present invention. For those ordinary technicians skilled in the art, other attached FIGURES can be obtained from these FIGURES without any creative work.

FIG. 1 is a flowchart of an embodiment of the present invention to provide a trusted document update.

### DETAILED DESCRIPTION OF THE PREFERRED EMBODIMENTS

The technical solutions in the embodiments of the present invention are clearly and completely described below with reference to the accompanying drawings in the embodiments. It is obvious that the described embodiments are only a part of the embodiments of the present invention, but not all embodiments. All other embodiments obtained by an ordinary technician skill in the art based on the embodiments of the present invention without departing from the inventive scope are in the scope of protection of the present invention.

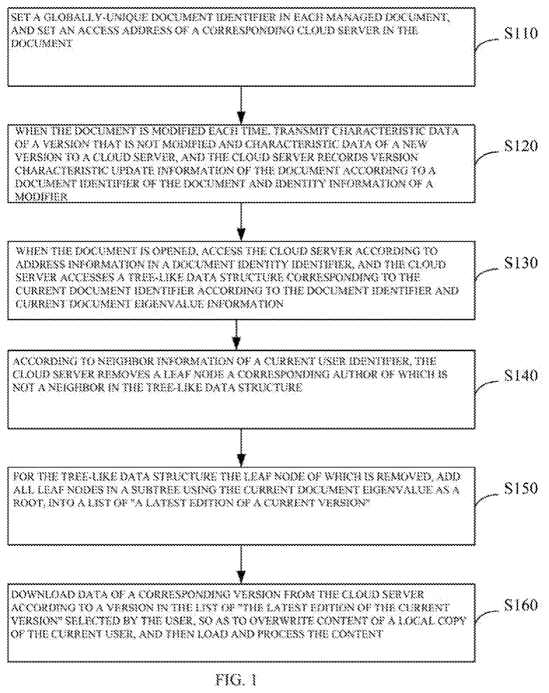

FIG. 1 is a flowchart of a method to provide a trusted document update according to an embodiment of the present invention. As shown in the FIGURE, the method for providing a trusted document update includes the following steps:

S110, setting a globally unique document identifier in each managed document (such as paging media electronic document: PDF document, Word document, etc.), and setting an access address to the corresponding cloud server in the document;

S120, each time a document is modified by a modifier, transmitting the pre-change version characteristic data that is not modified and the new version characteristic data that is modified to the cloud server, and the cloud server records the version feature update information of the document according to said document identifier and the identity information of the modifier, wherein the version characteristic data information corresponding to each document identifier is stored in a tree data structure; wherein, a subtree represents descendants of a node in the tree data structure; a leaf node is a node without any node below itself and directly connected with itself downward; a root is a node at the top in the tree data structure or in a subtree;

S130, as the document is opened, accessing the cloud server using set access address, and the cloud server accesses the tree data structure corresponding to a document identifier of a current document according to the document identifier and characteristic value information of the current document;

S140: said cloud server removing the leaf nodes whose authors are non-trusted neighbors (are not a friend/neighbor of a current user) in said tree data structure according to the friend/neighbor user information the current user identified;

S150. For the tree data structure rid of said leaf nodes, adding all leaf nodes in a subtree into a list of a “latest edition to the current version”, wherein, the characteristic value information of the current document is a root of the subtree.

S160: According to the version in the “latest edition to the current version” list selected by the current user, downloading the corresponding version of the data from the cloud server so as to overwrite the content in the local copy of the current user, and then loading and processing it.

In order to facilitate the user to edit other versions of the document, the above document updating method further includes the following steps:

To the tree data structure rid of said leaf nods, the leaf nodes not in the “Latest edits to current version” are added to the “Latest edits to other versions of current document” list;

According to the version in the “latest edition to other versions of the current document” list selected by the current user, the data of the corresponding version is downloaded from the cloud server to overwrite the content in the local copy of the current user, and then load and process it.

The cloud server is pre-uploaded with the friend/neighbor user information of the current user in order to facilitate the identification of the friend/neighbor users of the current user by the cloud server.

The invention conveniently solves the problem of version control of the document management system in the multi-user network environment, and provides a trusted document update mechanism under the premise of ensuring network utilization efficiency.

The following provides a method for updating a trusted document according to a specific embodiment of the present invention, including:

1. Place a globally unique document identifier in each managed document and indicate the access address of the corresponding cloud service in the identifier.

2. When each change is made to the document, the pre-change version characteristic data and the new version characteristic data are transmitted to the cloud service, and the cloud service records the version feature update information, each document identifier corresponds to a tree structure forming a set of characteristic data.

3. When the document is opened, access the cloud service according to the information in the document identifier, and provide the current user identifier, the document identifier, and the current document characteristic value information. The cloud service accesses the data structure corresponding to the current document identifier:
a. Remove all leaf nodes whose authors are non-trusted neighbors in said tree data structure according to the friend/neighbor user information the current user identified until there are no such leaf nodes:
b. In the tree structure, add all the leaf nodes in the subtree with the current document characteristic value as root into the “Latest Edit for Current Version” list.
c. For all leaf nodes of the entire tree, if they are not in the “Latest edition to current version” list, add the leaf nodes into the “Latest edition to other versions of current document” list.
d. Report the data of the “Latest Editing of Current Version” list and the “Latest Editing of Other Versions of Current Document” list to the user respectively.

4. If the user selects a version in a list, the version of the data is downloaded from the server, and then the content in the local copy is overwritten, then loaded and processed.

Compared with the prior art, the present invention has the following advantages:

This invention uses the version derivation tree under the document entry to manage the document version, and uses the document characteristic data instead of the full document identification version, thus the user needs to transmit less data to see all relevant updated versions information to select from, thereby increasing efficiency. This method ensures that the range of data obtained is from trusted neighbors, ensures the trustworthiness of the update results and the integrity of the information.

It will be understood by those of ordinary technician skilled in the art that the drawings are only a schematic diagram of an embodiment, and the modules or processes in the drawings are not necessarily required to implement the invention.

It will be understood by technicians skilled in the art that the modules in the device in the embodiment may be distributed in the devices of the embodiments according to the description, or may be correspondingly modified in one or more devices different from the embodiment. The modules of the above embodiments may be combined into one module, or may be further split into multiple sub-modules.

Finally it should be noted that the above embodiments are only used to illustrate the technical solutions of the present invention, and are not limited thereto; although the present invention has been described in detail with reference to the foregoing embodiments, those technicians skilled in the art should understand that the technical solutions described in the foregoing embodiments can be modified, or the equivalents of the technical features can be replaced, these modifications or substitutions do not depart from the spirit and scope of the technical solutions of the embodiments of the present invention.

1. A method for providing a trusted document update, wherein following steps are comprised:
Setting a globally unique document identifier in each managed document, and setting an access address of a corresponding cloud server in a document;
Transmitting a pre-version version characteristic data that is not modified and a new version characteristic data that is modified to the cloud server each time the document is modified by a modifier, said cloud server records version characteristic update information of the document according to the document identifier of the document and identity information of the modifier, wherein, the version characteristic data information corresponding to each document identifier is stored in a tree data structure; wherein, a subtree represents descendants of a node in the tree data structure; a leaf node is a node without any node below itself and directly connected with itself downward; a root is a node at the top in the tree data structure or in a subtree;
When the document is opened, accessing the cloud server by using the set access address, wherein, said cloud server accesses the tree data structure corresponding to a document identifier of a current document according to the document identifier and characteristic value information of the current document;
Said cloud server removing a leaf node whose author is not a friend/neighbor of a current user in said tree data structure according to friend/neighbor information of the current user;
For the tree data structure after said leaf node is removed, adding all leaf nodes in a subtree into a list of a “latest edition to the current version”, wherein, the characteristic value information of the current document is a root of the subtree;
According to the version in the “latest edition to the current version” list selected by the current user, downloading the corresponding version of the data from said cloud server to overwrite a content in the local copy of the current user, and then loading and processing it.

2. The method for providing a trusted document update according to claim 1, wherein following steps are comprised:
For the tree data structure after said leaf node is removed, adding leaf nodes not in the list of the “latest edition to the current version” into the a list of a “latest edition to other versions of the current document”;
According to a version selected by the current user in the list of the “latest edition to other versions of the current document”, downloading data corresponding to the version from said cloud server so as to overwrite the content in the local copy of the current user, and then loading and processing it.

3. The method for providing a trusted document update according to claim 1, wherein the document is a paged media electronic document.

4. The method for providing a trusted document update according to claim 1, wherein said cloud server has pre-uploaded friend/neighbor information of the current user.
